(19) United States
(12) Patent Application Publication
(10) Pub. No.: US 2007/0251822 A1
(43) Pub. Date: Nov. 1, 2007

(54) VISUAL HYDROGEN SENSORS USING NANOPARTICLES

(76) Inventors: William Hoagland, Boulder, CO (US); David K. Benson, Golden, CO (US); Rodney D. Smith, Golden, CO (US)

Correspondence Address: COCHRAN FREUND & YOUNG LLC, 2026 CARIBOU DR, SUITE 201, FORT COLLINS, CO, 80525, US

(21) Appl. No.: 11/553,400

(22) Filed: Oct. 26, 2006

Related U.S. Application Data
(63) Continuation-in-part of application No. 11/470,218, filed on Sep. 5, 2006.
(60) Provisional application No. 60/730,960, filed on Oct. 28, 2005.
(60) Provisional application No. 60/713,806, filed on Sep. 2, 2005.

(51) Int. Cl. G01N 27/26

(52) U.S. Cl. 204/424; 427/124

(57) ABSTRACT

Disclosed are chemochromic nanoparticles that can be used as pigments in paints, dyes, coatings, and inks. Because of the small size of the nanoparticles, there is an increased surface area of the chemochromic material that increases the speed of the response of the chemochromic material. The nanoparticles can also be employed in thin film detectors.

### CROSS REFERENCES TO RELATED APPLICATIONS

This application is a continuation-in-part of U.S. patent application Ser. No. 11/470,218 filed Sep. 5, 2006 by William Hoagland et al. entitled “Conformable Hydrogen Indicating Wrap to Detect Leaking Hydrogen Gas,” which claims the benefit of U.S. Provisional Patent Application Ser. No. 60/713,806 entitled “Conformable Hydrogen Indicating Wrap to Detect Leaking Hydrogen Gas” by William Hoagland et al. filed Sep. 2, 2005. These applications are specifically incorporated herein by reference for all that they disclose and teach. This application also claims the benefit of and priority to U.S. Provisional Patent Application Ser. No. 60/730,960 filed Oct. 28, 2005 by William Hoagland et al. entitled “Hydrogen Indicating Pigments to Detect Hydrogen Gas,” the entire content of which is specifically incorporated herein by reference for all that it disclosures and teaches.

### BACKGROUND OF THE INVENTION

Large quantities of hydrogen gas are used in numerous industries. Wherever hydrogen gas is used, detection of leaks is important. Most hydrogen gas detectors are large, bulky electronic devices that are capable of triggering safety devices such as shutoff valves and alarms.

### SUMMARY OF THE INVENTION

An embodiment of the present invention may therefore comprise a method of producing a hydrogen sensor using chemochromic nanoparticles comprising: obtaining transition metal oxide nanoparticles; coating the transition metal oxide nanoparticles with a catalyst to create the chemochromic nanoparticles; using the chemochromic nanoparticles in a hydrogen sensor.

An embodiment of the present invention may further comprise a chemochromic hydrogen sensor that uses a pigment that is made from nanoparticles comprising: nanoparticles of a transition metal oxide; a catalyst that is coated on a surface of the nanoparticles to form chemochromic nanoparticles for use as the pigment; an emulsion that is combined with the chemochromic nanoparticles for use as a chemochromic hydrogen sensor, the emulsion providing a protective layer for the catalyst.

### BRIEF DESCRIPTION OF THE DRAWINGS

FIG. 1 is a side view of one embodiment of a hydrogen sensor.

FIG. 2 is a perspective cutaway view of another embodiment of a hydrogen sensor.

FIG. 3 is a perspective cutaway view of another embodiment of a hydrogen sensor.

FIG. 4 is a schematic illustration of the application of one embodiment.

FIG. 5 is a schematic illustration of the application of another embodiment.

FIG. 6 is a perspective view of another embodiment of a hydrogen sensor.

FIG. 7 is a perspective view of the embodiment of FIG. 6.

FIG. 8 is a perspective view of another embodiment of a hydrogen sensor.

FIG. 9 is a top view of another embodiment of a hydrogen sensor.

FIG. 10 is a top view of another embodiment of a hydrogen sensor.

FIG. 11 is a graph illustrating the optical absorption of an indicator film at intervals during brief exposure to hydrogen.

FIG. 12 is a graph illustrating the transmittance of nano-powder WO3:Pt dispersed on a filter paper and exposed to 0.5% H₂₁N₂ mixture.

FIG. 13 is a graph illustrating the response time of a thin film indicator to 0.5% H₂/N₂ showing both fast and slow components.

FIG. 14 is a graph showing that the speed of response is proportional to the square root of the hydrogen concentration.

FIG. 15 is a graph illustrating the response limit of thin film indicators near 300 ppm H₂ in air.

FIG. 16 is a graph illustrating the temperature dependence of the response of the chemochromic nanoparticle indicators.

FIG. 17 is an Arrhenius plot of the response speed of the sensors versus inverse temperature for a high temperature and a low temperature.

FIG. 18 is a graph that illustrates the change in the response speed of the sensors as a result of exposure to laboratory air.

FIG. 19 is a graph illustrating the response time constant of a thin film indicator exposed to laboratory air and tested in 0.5% H₂/N₂.

FIG. 20 is a graph illustrating the fraction of response associated with the fast reaction, B1.

FIG. 21 is a graph showing the projected and measured performance after 49 days of laboratory exposure of the sensor materials.

FIG. 22 is a graph illustrating the estimated response curves after one year of exposure to laboratory air, based on parametric projections.

### DETAILED DESCRIPTION

In accordance with one embodiment, visual hydrogen sensors can be made using nanoparticles of chemochromic material, such as tungsten oxide (WO₃), that are coated with a noble metal catalyst, such as platinum or palladium. Various other transition metals can be used with various catalysts, as disclosed below. The catalyst is required to generate a chemochromic reaction with hydrogen. When the tungsten oxide nanoparticles that have been impregnated with a catalyst (such as platinum) are exposed to hydrogen gas, the catalyst causes the hydrogen gas to dissociate into atomic hydrogen so that atomic hydrogen may migrate into the tungsten oxide nanoparticles. The atomic hydrogen then chemically combines with the tungsten oxide to cause the chemochromic reaction. The diffused atomic hydrogen reacts with the tungsten oxide at the interface between the catalyst, such as platinum, and the tungsten oxide. The resulting partially reduced oxide absorbs light in the red portion of the visible spectrum so that white light falling on the chemochromic nanoparticles is reflected primarily in the blue portion of the spectrum. Under daylight or normal room lighting, the nanoparticles are seen to change from a dull gray color to a bright blue when exposed to hydrogen. The speed of the color change is dependent on many factors, as disclosed below. Once the source of gaseous hydrogen is removed, oxygen in the air gradually reoxidizes the partially reduced tungsten oxide and returns the nanoparticles to the original gray color.

The nanoparticles can be used as a pigment in coatings, dyes, paints and inks. Applications for paints, inks, dyes and coatings that include the chemochromic nanoparticles include the production of warning indicators for the presence of hydrogen gas in areas where such presence may pose a hazard, such as disclosed in U.S. Pat. No. 6,895,805, issued May 24, 2005 to William Hoagland entitled “Hydrogen Gas Indicator System,” which is specifically incorporated herein by reference for all that it discloses and teaches. As disclosed in detail in the above referenced patent, warning decals and signs can be employed that use the pigmented coverings, as well as active sensors that sense the variable resistance of coatings, dyes, paints and inks. In the presence of hydrogen gas, indicators can display a warning by changing the color of a printed message. In addition, objects may be painted with a paint that has the nanoparticle chemochromic pigmentation so that if a hydrogen leak occurs within or near the object, the color of the paint changes to provide a warning of the presence of hydrogen gas. Example applications of painted objects can be any object that is involved in an industrial process that includes hydrogen gas. For example, objects such as fuel inlet caps, refueling connectors, tanks, grounding connections, fuel cells and interconnecting piping of hydrogen-fuel vehicles, or various components of hydrogen-fueling stations, can be painted with a carrier, such as a coating, dye, paint, powder coat or ink that includes the chemochromic nanoparticle sensors.

Because of the extremely small size of the nanoparticles, i.e., typically 50 nm in diameter, the surface area of the interface between the catalyst and the tungsten oxide, which is partially reduced by atomic hydrogen, is greatly increased. As a result, the reaction speed is greatly increased by the use of nanoparticles. FIGS. 1-10 illustrate the manner in which chemochromic nanoparticles of tungsten trioxide (WO₃) or other chemochromic transition metal oxides can be employed as a sensor material 102 in a hydrogen sensor 100 that is employed as a plastic film.

FIG. 1 is a side view of a hydrogen sensor 100 comprising four components, a substrate 101, a sensor material 102, a catalyst 104 and an optional molecular diffusion barrier 106, all of which are described in more detail herein. The first component is a hydrogen sensor material 102 that may comprise transition metal oxides, or oxysalts such as vanadium oxide, tungsten oxide, molybdenum oxide, yttrium oxide, or combinations thereof, as examples. When exposed to atomic hydrogen, the metal oxide can be reduced to a lower oxidation state of the metal. Persons skilled in the art understand that a lower oxidation state means an oxidation state with fewer oxygen atoms in the compound than a higher oxidation state. For example, tungsten dioxide (WO₂) is a lower oxidation state of tungsten trioxide (WO₃). The reduction of the metal oxide to a lower oxidation state of the metal can be accompanied or manifested by a change in electrical conduction, electrical resistivity, electrocapacitance, magneto-resistance, photoconductivity, or optical properties of the hydrogen sensor 102 or in a combination of one or more of such changes. The change in such physical property or properties can be reversed by removing the transition metal oxide(s) from exposure to hydrogen and by exposing the sensor material 102 to oxygen, or the partial pressure of oxygen available in a mixture of gases, thereby converting the transitional metal oxide back to its original metal oxide state. In some embodiments, the hydrogen sensor material 102 may comprise chemochromic transition metal oxide such as, for example, but not by way of limitation, nanoparticles of tungsten trioxide (WO₃), which become noticeably darker in color upon conversion from a higher oxidation state of tungsten oxide to a lower oxidation state of tungsten oxide. The color change is reversible upon exposing the lower oxidation state of tungsten oxide to oxygen to convert it back to a higher oxidation state. There are many other chemochromic materials besides tungsten oxide that are well-known in the art and that can be used for the chemochromic hydrogen sensor material 102. The nanoparticles of tungsten trioxide can be deposited on a substrate layer 108 in any desired fashion including coating, spraying, depositing, painting and other methods.

In certain embodiments of the invention, by way of example, and not limitation, the hydrogen sensor material 102 can comprise a thin film of tungsten trioxide nanoparticles that are deposited on substrate 101 in a layer having a thickness of between about 0.2 microns to about 10 microns. The transition metal oxide layer of nanoparticles can be formed by vacuum vapor deposition, sputtering, electrophoretic, or other methods of metal deposition. The hydrogen sensor material 102 may be of a form as more fully described in the following references: U.S. Pat. No. 5,356,756 issued Oct. 18, 1994 to R. Cavicchi et al.; U.S. Pat. No. 5,345,213 issued Sep. 6, 1994 in the names of S. Semancik, et al., each of which is specifically incorporated herein by reference for all that they disclose and teach. In addition, the following articles also describe hydrogen sensor materials: J. S. Suchle, R. E. Cavicchi, M. Gaitan, and S. Semancik, “Tin Oxide Gas Sensor fabricated using CMOS Micro-hotplates and In Situ Processing,” IEEE Electron Device Lett. 14, 118-120 (1993); S. Semancik and R. E. Cavicchi, “The use of surface and thin film science in the development of advanced gas sensors,” Appl. Surf. Sci 70/71, 337-346 (1993); R. E. Cavicchi, J. S. Suchle, K. G. Kreider, M. Gaitan, and P. Chaparala, “Fast Temperature Programmed Sensing for Microhotplate Gas Sensors,” IEEE Electron Device Letters 16, 286-288 (1995); R. E. Cavicchi, J. S. Suchle, K. G. Kreider, B. L. Shomaker, J. A. Small, M. Gaitan, and P. Chaparala, “Growth of SnO.sub.2 films on micromachined hotplates,” Appl. Phys. Lett. 66 (7), 812-814 (1995); C. L. Johnson, J. W. Schwank, and K. D. Wise, “Integrated Ultra-thin film gas sensors,” Sensors and Act B 20, 55-62 (1994); X. Wang, W. P. Carey, and S. S. Yee, “Monolithic thin film metal oxide gas sensor arrays with application to monitoring of organic vapors,” Sensors and Actuators B 28, 63-70 (1995); N. R. Swart and A. Nathan, “Design Optimization of integrated microhotplates,” Sensors and Act A 43, 3-10 (1994); and N. Najafi, K. D. Wise, and J. W. Schwank, “A micromachined thin film gas sensor,” IEEE Electron Device Lett. 41 (10) (1994); F. DiMeo Jr., S. Semancik, R. E. Cavicchi et al., “MOCVD of SnO.sub.2 on silicon microhotplate arrays for use in gas sensing application,” Mater. Res. Soc. Symp. Proc. 415, 231-6 (1996).

Referring again to FIG. 1, the second component of the hydrogen sensor 100 comprises a catalyst material 104 that facilitates the conversion of molecular hydrogen to atomic hydrogen. With respect to some embodiments of the invention, the catalyst material 104 can be selected from the group comprising platinum, palladium, rhodium, nickel, combinations of these metals, or alloys of these materials with other metals such as copper, cobalt, iridium, magnesium, calcium, barium, strontium, or the like. The catalyst material 104 can be applied directly to the hydrogen gas sensor, as described above, and can have thickness, for example, but not by way of limitation, of between about 0.001 micron to about 10 microns.

A third component of the hydrogen sensor 100 can comprise a molecular diffusion barrier 106 that allows selectively permeable diffusion of molecular hydrogen or atomic hydrogen to at least the partial exclusion of oxygen and other contaminants. The molecular diffusion barrier 106 is preferably a continuous barrier and has an atomic density that provides an effective barrier against unwanted oxidation of the transition metal oxide of the hydrogen sensor material 102. The thickness of the molecular diffusion barrier layer 106 can be readily selected to minimize oxygen permeation, while maximizing the response of the hydrogen sensor material 102 to atomic hydrogen. The protective molecular diffusion barrier 106 can comprise at least one thin metal film such as palladium, platinum, iridium, or other noble metals, or precursors of such metals that may be used for deposition, or can comprise a polymer such as: polyamides, polyacrylamides, polyacrylate, polyalkylacrylates, polystyrenes, polynitriles, polyvinyls, polyvinylchlorides, polyvinyl alchohols, polydienes, polyesters, polycarbonates, polysiloxanes, polyurethanes, polyolefins, polyimides, or heteropolymeric combinations thereof. See U.S. Patent Publication No. 20010012539, which discloses diffusion barrier layers and is specifically incorporated herein by reference for all that it discloses and teaches. The molecular diffusion barrier 106 can be coupled to the catalyst material, or in those embodiments of the invention that do not employ a catalyst layer 104, can be coupled to the hydrogen sensor material 102. In one embodiment, the molecular diffusion barrier is a layer of PTFE having a thickness of approximately 100 nm.

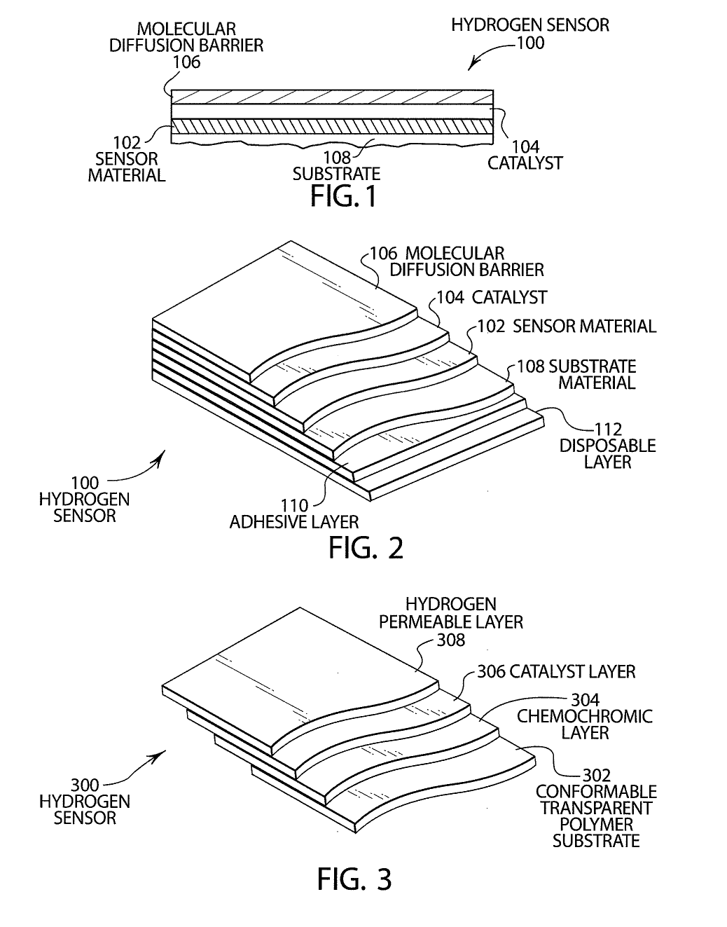

Referring to FIG. 2, the substrate material 108 supports the hydrogen sensor 100. The substrate material 108, with respect to some embodiments of the invention, can be selected from the group of glass, metal, mineral, plastic, paper, or conformable plastic films such as shrink-wrap films (polyolefin) and self-adhering films, such as are used for wrapping foods or the like. The substrate material 108 can be configured as blanks cut from substantially rigid sheet material, or the substrate material 108 can be a flexibly conformable material that can conformably mate with other objects that carry, interact with, or are employed in the distribution of hydrogen gas, such as pipes, containers, pumps, or the like as described in more detail below. Further, the substrate material 108 can be a rigidly configured material that makes up a component or element that is assembled as part of a construct to carry, interact with, or is employed in the distribution of hydrogen gas. Further, the substrate material 108 can be a material installed or used within an enclosed area in which hydrogen gas can collect. The substrate material 108 can also be a material used to make clothing, outerwear, or accessories worn by individuals that work or utilize spaces, areas, or enclosures that can potentially bring them into contact with hydrogen gas. Further, the substrate material 108 can be configured to fit into a container, holder, sampler, badge, or other construct in manner that the hydrogen gas indicator can interact with the gaseous environment.

An adhesive layer 100 can also be provided on at least a portion of the surface of the substrate material 108, such that the substrate material can be adhesively attached to structures similar to adhesive tape. The invention may also further comprise a disposable layer 112 to which the substrate material 108 having an adhesive layer 110 on at least a portion of the surface can be separably or peelably joined, such as decals, adhesive strips, adhesive dots, or the like.

The substrate material 108 can be a friable substrate that can be crumbled or broken into particles. The friable substrate 108 can be made to support the hydrogen sensor material 102 prior to being crumbled or broken into particles such that only a portion of the surface of the particle of the friable substrate material 108 supports a hydrogen sensor material 102. Alternatively, the particles of the friable substrate material 108 can be made to support the sensor material 102 after the friable substrate material 108 is crumbled, broken, or reduced in size to particles such that all the surfaces of the resulting particles support the sensor material 102. Naturally, the particles may also be made from other types of materials or result from different processes (such as machining, molding, or the like) and can comprise numerous particle sizes, types, or kinds in homogeneous populations or mixtures thereof. The particles that support the sensor material 108 may be sized to be used as pigments within liquid substances, such as paint, polymers, elastomers, gels, or the like. For example, a substrate material, such as finely ground mica or talc, can be used to deposit the sensor material. For example, the tungsten trioxide may be vacuum deposited onto particles of mica, talc or other small particles that are of a size suitable for use as pigments in paint or ink. The coated particles can then be harvested from the deposition equipment and used directly as pigment. Vibrating bed trays or other devices may be used to provide agitation to the small particles to expose more of these small particles to the deposition of the tungsten trioxide during the deposition process.

FIG. 3 is a schematic illustration of an embodiment of a hydrogen sensor 300. Hydrogen sensor 300 has a conformable transparent polymer substrate 302. The conformable transparent polymer substrate 302 can comprise a plastic film, such as commercially available plastic wrap for wrapping foods, or a shrink-wrap type of material. Commercially available plastic wraps have the advantage of clinging to objects when wrapped on those objects, as well as clinging to themselves when wrapped around objects. These types of plastic wraps are conformable to the object and provide the additional benefit of securing the hydrogen sensor 300 to the object in a simple and easy fashion by either clinging to the object, or clinging to itself, when wrapped around the object. In the case of a shrink-wrap type material, the polymer shrink-wrap that comprises the conformable transparent polymer substrate 302 can be wrapped around the object and have heat applied to the wrap to shrink the wrap and thereby fully encapsulate the object. In this manner, the capture of the hydrogen emanating or evolving from the object with the hydrogen sensor 300 can be ensured, and the hydrogen sensor 300 can provide an indication of any such hydrogen.

A chemochromic hydrogen sensor material 304 is placed on the conformable transparent polymer substrate 302 in any of the ways that the sensor material 102 is placed on the substrate material 108, as described with respect to FIG. 2. The catalyst layer 306 is applied to the chemochromic hydrogen sensor material 304 in the same manner that the catalyst 104 is applied to the sensor material 102 of FIG. 2. Further, the hydrogen permeable barrier layer 308 is applied to the catalyst layer 306 in the same manner that the molecular diffusion barrier 106 is applied to the catalyst layer 104. The chemochromic hydrogen sensor material 304 can comprise any of the hydrogen sensor materials, such as the sensor materials 102 described above. The catalyst layer 306 can comprise any of the catalysts, such as catalyst 104 described with respect to FIG. 2. The catalyst layer 306, for example, can be a noble metal catalyst layer such as platinum or palladium, or other noble metals. The hydrogen permeable layer 308 can comprise any of the molecular diffusion barriers 106 that are described with respect to FIG. 2. The hydrogen permeable layer 308 provides a protective coating for mechanical and chemical protection of the chemochromic sensor material 304 and the catalyst layer 306. The hydrogen permeable layer 308 is a protective coating that is semi-permeable. The protective coating of the hydrogen permeable layer 308 allows hydrogen to pass through the permeable layer 308 that excludes elements or compounds that would deactivate or otherwise damage the chemochromic sensor material 304. The hydrogen permeable layer 308 may comprise various forms of PTFE (Teflon®) as well as other types of materials.

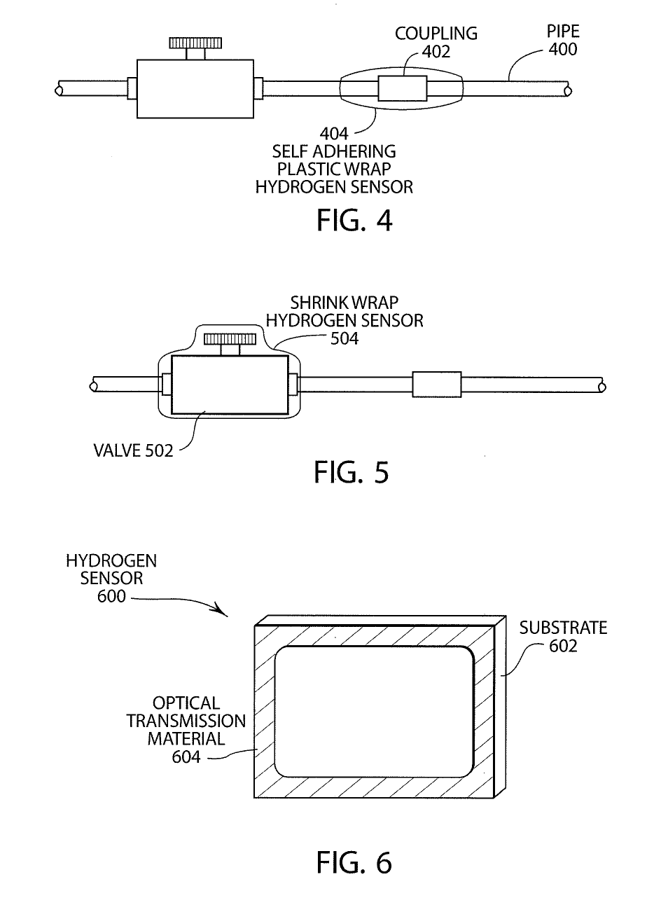

FIG. 4 is a diagrammatic illustration of the use of a self-adhering plastic wrap or cling wrap hydrogen sensor 404 being used to sense hydrogen leaks from a coupling 402 in a pipe 400. As shown in FIG. 4, the self-adhering plastic wrap hydrogen sensor 404 is wrapped around the coupling 402 and adheres to the coupling 402 and pipe 400 as well as to itself. The plastic wrap 404 is wrapped so that the conformable transparent polymer substrate 302 (FIG. 3) is on the outside and the hydrogen permeable layer 308 is on the inside of the wrap adjacent the coupling 402 and pipe 400. If hydrogen leaks from the coupling 402, the hydrogen sensor 404 will change colors or darken, which indicates a hydrogen leak. The transparent polymer sheets that comprise the conformable transparent polymer substrate 302 of the self-adhering plastic wrap hydrogen sensor 404 allow the change in color or transparency to be viewed by an observer. Of course, automated means can be employed to detect a change in color or transparency, such as the use of electro optic sensors. The self-clinging properties of the conformable transparent polymer substrate 302 allow the hydrogen sensor 300 to be easily disposed on various objects and easily conformed to the shape of those objects. The hydrogen sensor 300 overlaps itself and is held in position by the self-clinging properties of the conformable transparent polymer substrate 302.

FIG. 5 is a schematic illustration of the use of a shrink-wrap hydrogen sensor 504 that encapsulates a valve 502. In this embodiment, the conformable transparent polymer substrate 302 (FIG. 3) comprises a heat-shrink plastic film that is typically, but not necessarily, made from a polyolefin polymer that is used for security packaging of retail items. In this case, the hydrogen sensor 504 includes each of the layers illustrated in FIG. 3. The conformable transparent polymer substrate 302 in the shrink-wrap hydrogen sensor 504 is a shrink-wrap material. The shrink-wrap hydrogen sensor 504 is wrapped around the valve 502 or other object, which is to be monitored for hydrogen. Shrink-wrap hydrogen sensor 504 is then heated moderately to cause it to shrink and conform to the shape of the valve 502. In this manner, the valve 502 is encapsulated by the shrink-wrap hydrogen sensor 504 to ensure a reliable detection of hydrogen that may leak from the valve 502. Of course, any object can be encapsulated in this manner. As disclosed below, the self-adhering plastic wrap hydrogen sensor 404, as well as the shrink-wrap hydrogen sensor 504, can be encoded with indicia to indicate the existence of hydrogen.

Referring to FIGS. 6, 7, 8, and 9, a hydrogen sensor is illustrated that has discrete indicia 700 that are responsive to hydrogen. The indicia 700 comprise the hydrogen sensor material 702 and provide indication of detection of hydrogen gas. Alternatively, the discrete indicia 700 are operatively connected to the hydrogen sensor material 802 and provide an indication of the detection of hydrogen in a manner that is discrete from the change in physical, chemical, or electrical properties of the hydrogen sensor material 802 itself. With respect to some embodiments of the invention, discrete indicia 700 can include alpha-numeric characters or symbols arranged in any number, variety or combination of languages or notations. The alpha-numeric indicia or symbols, while operatively responsive to the hydrogen sensor material 802, provide additional indicia discrete from any information that can be obtained directly from the hydrogen sensor material 802 itself. The alpha-numeric indicia 700 can, as examples, provide a warning, or could provide instructions, or could provide a map, or display, present, or provide any other information, instruction, or guidance, in response to the presence of hydrogen gas.

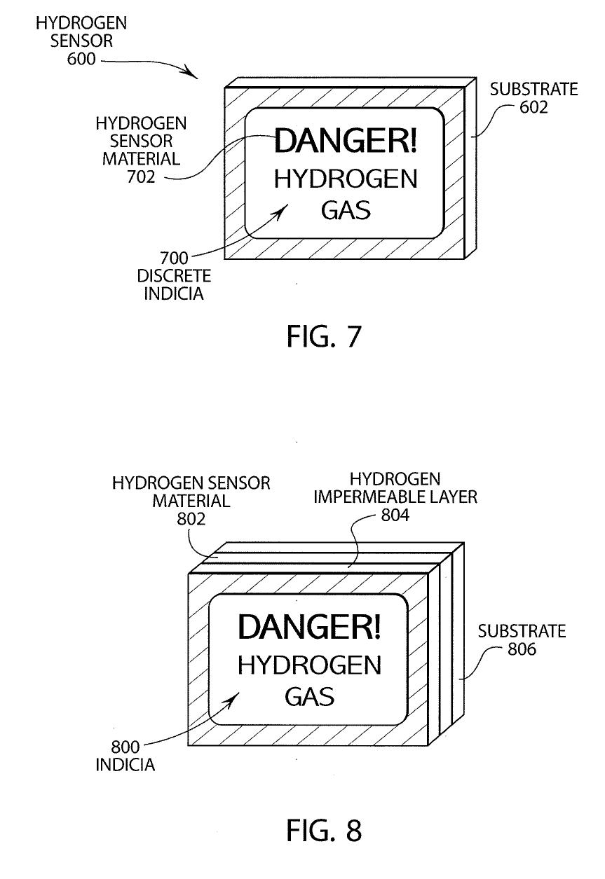

The following illustrative examples of discrete indicia 700 are not meant to limit the numerous and varied embodiments of discrete indicia that can be made operably responsive to the hydrogen sensor material 802. As shown by FIGS. 6 and 7, certain embodiments can comprise a substrate material 602 having an optical transmission material 604 coupled to portions of the surface of the substrate material 602. The optical transmission material 604 can comprise ink, paint, dye, or other pigmented material, but can also comprise a texture added to the surface of the substrate material 602 during molding or configuration of the substrate material 602, or can be the result of other treatment of the surface of the substrate material 602, such as particle blasting, surface abrasion, electroplating, chemical vapor deposition, or the like. Discrete indicia 700 that indicate the presence of hydrogen gas are then added, such as the words “Danger! Hydrogen Gas” that are operably responsive to the hydrogen sensor material 302, so that this discrete indicia 700 are provided only in response to the presence of hydrogen gas.

In certain embodiments of the invention, a portion of the surface of the substrate material 602 can be masked or protected leaving unmasked or unprotected surface configured as discrete indicia 700. The substrate can then be processed by the various methods described above to couple hydrogen sensor material 702 to the unmasked portion of the substrate material 602 generating discrete indicia 700 that are observable when the hydrogen sensor material 802 is exposed to hydrogen gas.

In other embodiments of the invention the discrete indicia 700 can be applied as a dye, ink, paint, gel, polymer, or other substance that can entrain pigment particles of the sensor material 702. Such particles can include the catalyst material 104 or the molecular diffusion barrier layer 106, or both, as homogeneous populations of particles or in various combinations or permutations. The color or opacity of the substance entraining the particles of the hydrogen sensor material 702 that are applied as discrete indicia 700 can change from a first color or opacity, to a second color or opacity, in the presence of hydrogen gas.

Referring to FIG. 8, conventional optical transmission material 604 (FIG. 6) does not have to be incorporated into all embodiments. In certain embodiments, a portion of the surface of the substrate material 806, as desired, can be coupled to the hydrogen sensor material 102, and a further hydrogen impermeable material 804 can be coupled to selected portions of the hydrogen sensor material 102, which can in some embodiments of the invention also include the catalyst material 104 or the molecular diffusion barrier 106, that is selectively permeable to hydrogen gas, or both, leaving discrete indicia 800 configured in the hydrogen impermeable layer 804. When the substrate material 806 is then exposed to hydrogen gas, that portion of the hydrogen sensor material 802 that is not covered by impermeable material 804, which is configured with discrete indicia 800, reacts with the hydrogen gas providing viewable discrete indicia 800. Upon removal from hydrogen gas, the hydrogen sensor material 802 can return to the oxidized color of the transition metal to match the color of the hydrogen sensor material that is covered by the hydrogen impermeable layer 804. The discrete indicia 800 become substantially indiscernible.

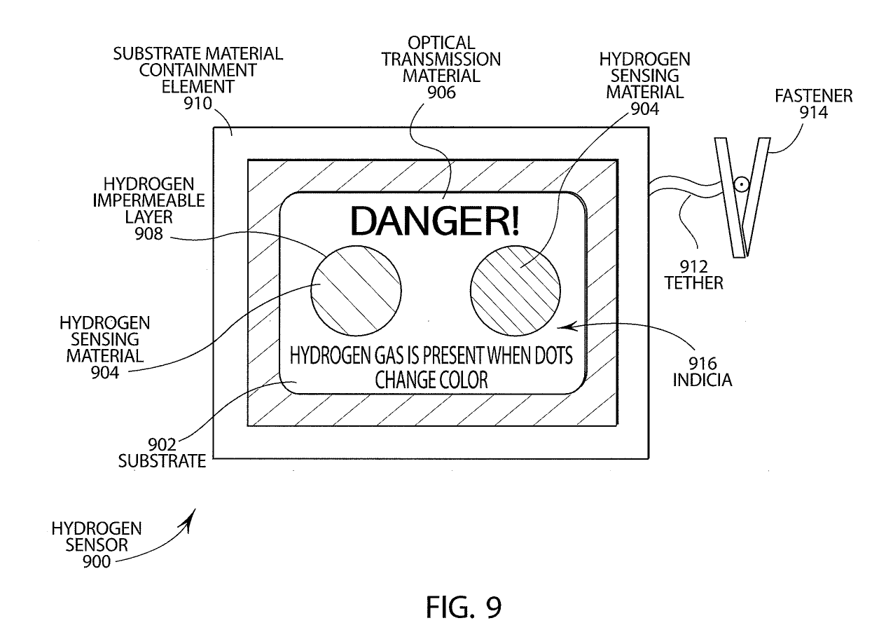

FIG. 9 illustrates another embodiment of a hydrogen sensor 900 that includes a substrate material 902, a hydrogen sensor material 904, a catalyst material 104, a molecular diffusion barrier 106, a hydrogen impermeable material 908 and conventional optical transmission materials 906. The invention can further comprise a substrate material containment element 910. As shown in FIG. 5, the substrate material containment element 910 can be configured to hold the substrate material 902 in a badge or accessory to be worn on clothing. In certain embodiments, a tether 912 can be joined to the containment element 910 terminating in a fastener 914, which can include pins, clips, clasps, adhesive, or the like. The tether 912 can be attached directly to the substrate material 902. The substrate material can also be a substrate material 902 conformable to outerwear, such as a plastic sheet or paper sheet, having an adhesive layer 110 (FIG. 2) coupled to at least a portion of the conformable substrate material 902. As to these embodiments, a person can simply press the adhesive layer to outerwear and peel the substrate material 902 from the outerwear for disposal, if desired. As described above, the adhesive layer 110 can be separably or peelably joined to a disposable layer 112 for convenience of storage, or the convenience of manufacture wherein a large quantity of a particular substrate material 902 with particular discrete indicia 916 are to be made.

The containment element 910 can also comprise a container to which hydrogen gas sensor nanoparticles are transferred. Hydrogen gas sensor nanoparticles can have a mixture of gases passed over or through them as a manner of sampling the gaseous environment. The containment element holding the hydrogen sensor particles can be at a location remote from the gaseous mixture being sampled. The gaseous mixture being sampled is transferred to the hydrogen gas indicator by way of a closed conduit communicating between the gaseous mixture and the containment element 910.

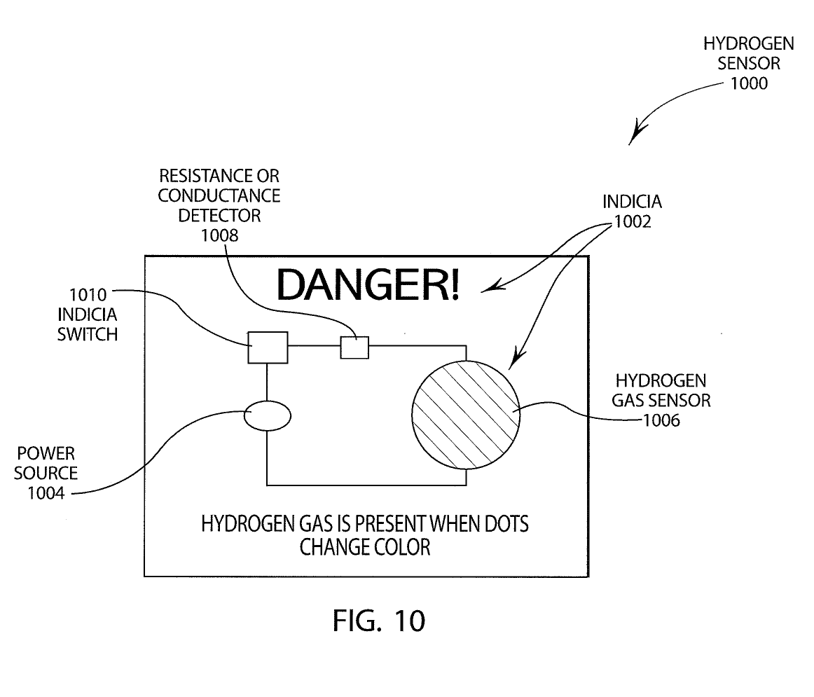

Now referring primarily to FIG. 10, embodiments of a hydrogen sensor 1000 can further include circuitry that utilizes the reversible electrical properties of the hydrogen sensor material 1002, including the catalyst material 104, or the molecular diffusion barrier 1006, or both, as desired, as a manner of switching certain discrete indicia 1002 on or off. A power source 1004, which could be a battery, photovoltaic cell, or other type of power source, provides current, while the hydrogen gas sensor 1006 provides a variable resistance or conductance in response to exposure to hydrogen gas. A resistance or conductance differentiation detector 1008 can be further added to the circuitry as required or desired. When the hydrogen gas sensor 1006 is exposed to hydrogen gas, the resistance or conductance of the hydrogen gas sensor 1006 changes. This change is used to switch the indicia switch 1010 to turn the switchably operable discrete indicia on or off. Switchably operable discrete indicia can include a signal generator that provides a visual or audible or tactile signal. The audible signal generator can generate a digitized message, or a tone. The tactile signal generator can generate a vibration or modulated frequency that can be felt by a person in proximity to the hydrogen sensor 1000. The visual generator can turn on an illumination source.

The sensor material that is made from nanoparticles of a transition metal, in addition to being used in film applications, can also be used as a pigment in coatings, dyes, paints, powder coatings or inks. As indicated above, application of the nanoparticle sensors in a coating, dye, paint, powder coat or ink facilitates the use of the hydrogen sensor as a visual hydrogen gas indicator. Visual hydrogen gas indicators may be helpful in various circumstances. In a first type of a circumstance, a hydrogen gas leak is not an immediate safety concern, but must be detected and remedied. No electronic signal is needed because an operator is on hand to make the needed remedy. In the second kind of circumstance, a visual hydrogen indicator facilitates the location of the hydrogen source, complementing electronic sensors which have already responded to hydrogen gas presence within a large area. A third circumstance is where the hydrogen leak is so small that conventional electronic detectors may not be sensitive enough or may not be needed to signal safety devices, but nevertheless, the insidious leak must be detected and located to facilitate preventive maintenance. Finally, an indicator may provide reassurance where a leak is unlikely to be a safety concern; but where the signaled absence of a leak could ease the concerns of a gas user. An example of each of the circumstances is described below. Of course, there will be many other applications for such versatile hydrogen gas indicators.

In a first example, hydrogen gas lines are being installed in a facility such as a semiconductor fabrication plant. After each orbital weld or mechanical coupling is installed, the pipefitter wraps a piece of indicator tape around the joint and calls for a helper to momentarily pressurize the line with a safe hydrogen gas mixture, such as forming gas. If the fitting is faulty, hydrogen will leak to the indicator. The visual indicator will turn dark blue and the pipefitter can rework and retest the fitting. This immediate location and repair of faulty fittings may reduce installation costs.

In another example, pipe fittings and valve stems in a large complex chemical processing plant may be wrapped with a conforming plastic indicator sheet very similar to kitchen cling wrap. If a leak develops in any of these fittings, conventional electronic area-wide detectors will detect the leak and signal the activation of automatic shutdown valves and alarms. Responding technicians can then look at the fittings and valves and immediately identify the offending one by the dark blue color of the indicator. This ability to quickly locate the leak may reduce maintenance costs.

Further, a composite high-pressure hydrogen vehicle fuel storage tank may be “shrink wrapped” with an indicator film so that if a small leak begins to develop, the indicator wrap will turn blue. The faulty tank can then be replaced at the next maintenance opportunity, well before the leak develops into a safety concern. This kind of early warning may reduce product liability costs.

As another example, the underside of the lid of a fueling port on a hydrogen-fueled vehicle is painted with a hydrogen gas indicator. During refueling, the fittings in the port may leak some hydrogen. In virtually every circumstance, this leaked hydrogen would be less dangerous than the gasoline fumes that can be smelled during refueling of cars, but a new hydrogen vehicle operator may have exaggerated fears. These fears may be allayed by knowing that the hydrogen indicator on his refueling port has not turned blue. This kind of reassurance may improve public acceptance of hydrogen-fueled vehicles.

Nanoparticles of tungsten are made commercially by gas-phase plasma reaction in vacuum and are subsequently coated with a partial layer of platinum or palladium catalyst by conventional chemical techniques, such as disclosed by S. H. Joo, S. J. Choi, et al., “Ordered Nanoporous Arrays of Carbon Supporting High Dispersions of Platinum Nanoparticles.” Nature, Vol. 412, pp. 169-172, Jul. 12, 2001. These nanoparticles are typically 50 nm in diameter and can be used as pigments in indicator paints, coatings and inks. Nanoparticles of tungsten trioxide can be purchased from Nanoproducts Corporation, 14330 Longs Peak Court, Longmont, Colo. 80504.

Alternatively, nanoparticles of tungsten trioxide can be made in the manner similar to the way in which nanoparticles for sol gel films are made. The process basically comprises oxidation of finely divided tungsten metal powder or other transition metal powder. Finely divided tungsten metal powder is available at many chemical warehouses. The tungsten metal powder may have a 100 or 200 mesh size. The tungsten metal powder is then reacted with hydrogen peroxide until the particles are small enough that they become suspended in the liquid. The tungsten particles are dissolved until they reach a nanoparticle size. At that point, finely divided platinum, i.e., platinum black, is added to the solution to stop the reaction. The solution is then filtered to obtain the nanoparticles of tungsten trioxide. These tungsten nanoparticles are then impregnated with a catalyst.

Another method of manufacturing nanoparticles uses a process of spray pyrolysis. To create tungsten trioxide, a solution, such as tungstic acid or other soluble form of tungsten, such as sodium tungstate in a soluble form, can be used to generate a fine mist of a tungsten solution. Various soluble tungsten solutions can be used for this process. The fine mist is then sprayed into a high temperature furnace so that the individual droplets react to form an oxide. In this fashion, very small particles that have nanoparticle sizes can be made using the spray pyrolysis technique.

The process of coating the nanoparticles of tungsten trioxide or other transition metal with a catalyst is described below with respect to platinum. Hexachloroplatinic acid is used as a solution of soluble platinum. The hexachloroplatinic acid is then dissolved in a solvent, such as ethanol, acetone or isopropyl alcohol. The amount of hexachloroplatinic acid is adjusted so that the final concentration in the solvent is about one weight percent of a 5 gram sample of the tungsten trioxide nanoparticles. For a 5 gram sample of the tungsten trioxide powder, a small amount of solvent is required. Typically, 10 to 15 ml of solvent is used to dissolve the acid. The powder is then added to the solution. The powder is soaked in the solution of solvent and hexachloroplatinic acid and placed in an oven at 60 to 70° Celsius to dry for approximately 16 hours. The nanoparticles of tungsten trioxide are coated with the solution as the solvent is evaporated so that a chloroplatinate coating is formed on the surface of the individual tungsten trioxide nanoparticles. The chloroplatinate is then reduced to the tungsten trioxide. This is done by placing the coated nanoparticles in a tube furnace in an inert atmosphere. A forming gas, which is 10 percent hydrogen and 90 percent nitrogen, is passed over the coated nanoparticles at a flow rate of approximately 150 ml per minute. The oven is then ramped up to 300° C. over a period of approximately 2 hours. This causes the palatinate, that is basically ionic and associated with a chloride, to be reduced to the tungsten metal. The catalyst reduces on the tungsten trioxide nanoparticles and forms multiple small metallic islands of platinum on the surface of these nanoparticles. The nanoparticles are highly colored because hydrogen from the forming gas reacts with the tungsten oxide. The nanoparticles appear as a dark blue color. The furnace and the forming gas are then turned off, and the powder is allowed to cool to room temperature in air. This process reverses the color reaction, and the platinum remains on the surface of the tungsten nanoparticles. The grayish or uncolored nanoparticles turn blue very quickly when re-exposed to hydrogen.

Tungsten trioxide (WO₃) is a well known chromogenic material, i.e., WO₃, undergoes color changes under various circumstances. These color changes accompany a change in the oxidation state of some of the tungsten ions in the normally transparent crystalline WO₃. Partial reduction of the WO₃ replaces some of the W⁶⁺ ions with W⁵⁺ ions. Because of the high dielectric constant of WO₃, a free electron in the vicinity of a W⁵⁺ ion is trapped in a polarization field around the W⁵⁺ ion. This kind of trapped electron is called a polaron and exhibits quantized optical absorption similar to those of orbiting electrons in a simple atom as disclosed by S. H. Joo, S. J. Choi, et al., “Ordered Nanoporous Arrays of Carbon Supporting High Dispersions of Platinum Nanoparticles.” Nature, Vol. 412, pp. 169-172, Jul. 12, 2001. However, the interaction of the electron with the thermal vibrations of the WO₃ lattice spreads the optical transitions into a broad absorption band that peaks near 800 nm and extends into the red portion of the visible spectrum. Consequently, the partially reduced WO₃ appears blue.

The crystalline WO₃ can be partially reduced in numerous ways, i.e., by heating in a non-oxidizing atmosphere, electrochemically in a cell configuration, or by chemical reaction with a reducing agent such as lithium or hydrogen. Thin films of WO₃ have been used is various applications. In electrochromic windows the WO₃ film is reversibly darkened by applying a small voltage across a multi-layer thin film electrochemical cell made up of the WO₃, a solid electrolyte and a counter-electrode layer, all of which are applied to the window glass in a vacuum deposited multi-layer coating. In a similar application, “gasochromic” windows can be dimmed by reversibly introducing hydrogen gas into the sealed gap between glass panes of a sealed insulating glass window as disclosed by S. M. Lee, P. L. Hyeonsik, P. L. Cheong, D. Smith, C. E. Tracy, et al., “Gasochromic Mechanism in a-WO₃ Thin Films Based on Raman Spectroscopic Studies, J. Applied Physics, Vol. 88, No. 5, pp. 3076-3078, Sep. 1, 2000. A thin coating of WO₃ and platinum or palladium turns dark in the hydrogen gas. WO₃ thin films have also been used in various designs of hydrogen gas detectors including the authors' designs for a fiber-optic hydrogen detector as disclosed by D. K. Benson, C. Bechinger, and C. E. Tracy, “Fiber Optic Device for Sensing the Presence of a Gas,” U.S. Pat. No. 5,708,735, Jan. 13, 1998, a bio-hydrogen screening device as disclosed by M. Seibert, D. K. Benson, and T. M. Flynn, “System for Rapid Biohydrogen Phenotype Screening of Microorganisms Using a Chemochromic Sensor,” U.S. Pat. No. 6,448,068, Sep. 10, 2002, and a detector for hydrogen gas dissolved in welded metal as disclosed by R. D. Smith, D. K. Benson, et al., “The Determination of Hydrogen Distribution in High-strength Steel Weldments Part 2: Opto-electronic Diffusible Hydrogen Sensor,” American Welding Society, http://files.aws.org/wj/supplement/SmithPart2-05-01/pdf. In each of these designs, a catalyst is applied to the thin film WO₃ to increase its reaction rate with hydrogen gas.

The nanoparticles of tungsten trioxide that are coated or impregnated with platinum provide an excellent pigment for coatings, dyes, paints and inks. The powder can be used as a pigment base for a variety of different emulsions. Various emulsions are available from Insignia Specialty Coatings, LLC, P.O. Box 231, El Dorado, Kans. 67042. A suitable emulsion for a paint, dye, coatings or ink preferably encapsulates the nanoparticles to insulate the nanoparticles from atmospheric contamination, and also does not adversely affect the catalyst. In addition, the emulsion should provide a coating that is porous enough to allow hydrogen gas to penetrate the protective layer. Water-based emulsions for paints, inks, dyes and coatings appear to provide the best properties.

As referred to above, the pigment can also comprise a base material that has the chemochromic tungsten nanoparticles deposited onto the base material or substrate, such as by vacuum deposition or other known techniques, as well as a catalyst and a protective film. The base material can comprise any desirable substrate, such as paper, glass, or any material that can be ground into nanoparticles. The substrate is then crushed to form particles that are small enough to act as a pigment, i.e., that can be suspended in an emulsion of a paint, dye, coating or ink. In this fashion, the tungsten trioxide nanoparticles are coated with a catalyst and a protective layer on a substrate prior to the substrate being crushed to a size that is suitable for use as a suspendable pigment. The powder could be used in a number of ways, even as an aerosol. As also mentioned above, small particles of a substrate, such as mica, talc or small particles, can be coated or impregnated with the nanoparticles of the transition metal oxide that is coated with a catalyst in any desired fashion, including vacuum deposition techniques, to provide a pigment for paints, dyes, inks and other coatings.

In addition, typical pigments that are used in paints, such as titanium dioxide and aluminum oxide, can be coated or impregnated with the chemochromic nanoparticles. In this fashion, titanium dioxide, aluminum oxide, or other normal pigmentation that can be added to paint is used as a support or substitute for the impregnation of chemochromic nanoparticles. Small particles of titanium dioxide or aluminum oxide that approach the nanoparticle size can be coated with tungsten trioxide using an impregnation technique. For example, a transition metal, such as tungsten, can be dissolved to form a solution, such as tungstic acid. The tungstic acid is then dissolved in a solvent, such as ethanol, acetone or isopropyl alcohol. A titanium dioxide or aluminum oxide powder of nanoparticles is then added to the solution of the solvent in the tungstic acid. The mixture is placed in an oven at about 60 to 70° Celsius to dry for about 16 hours. Once the solvent evaporates, a coating of tungsten trioxide covers the titanium dioxide or aluminum oxide nanoparticles. The process of coating the catalyst on the tungsten trioxide can be performed using the same coating process as disclosed above, in a subsequent step, or simultaneously with the coating of the tungsten oxide on the nanoparticles. In this fashion, nano size pigmentation particles, such as titanium dioxide and aluminum oxide can be coated with a chemochromic material that can be used in paints, dyes, coatings and inks.

Various emulsions that are used in paints, dyes, coatings and inks provide a level of protection to the chemochromic materials to protect the catalyst layer from contaminants. In applications where an emulsion does not provide such a protective layer, micro-encapsulation techniques can be used to encapsulate the micro-particles. The process of micro-encapsulation provides a protective polymer coating, such as PTFE or polyethylene, that encapsulates the nanoparticles. Standard processes of using an emulsion of PTFE or other protective coating can be used to micro-encapsulate the nanoparticles and thereby protect catalyst layers from contamination.

Key to the proper function of a visual indicator for hydrogen is the kinetics of its response and how these kinetics change over the useful life of the indicator. Different applications for the indicator will have different requirements for both speed and durability. Dynamic measurements of the changes in optical absorption of prototype indicators have been made as these chemochromic indicators are exposed to different concentrations of hydrogen gas mixtures. Understanding and guidance in the development of products have been provided by analyzing these response curves in detail and fitting them to mechanistic models.

The basic measurement that is made in these analyses is a recording of the optical transmittance of a test coupon as it is exposed to hydrogen. The sample is housed in a simple fixture that clamps the sample between a backing plate and an o-ring sealed chamber of less than one cubic centimeter volume. A gas mixture is fed through the chamber from a manifold of mass-flow controllers. Each of the controllers controls the flow of a different gas from the bank of compressed gas cylinders so that the desired mixture may be reproducibly applied to the sample chamber.

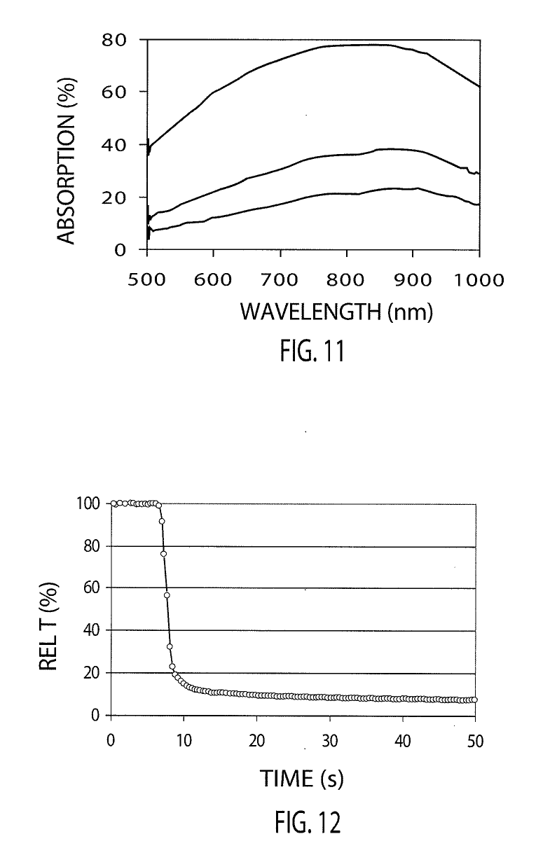

The optical transmittance is measured with a spectrometer that is capable of measuring and recording the full spectrum from about 500 nm to 1100 nm each fraction of a second repeatedly throughout the exposure period. A white light source is directed to the sample by an optical fiber and the transmitted beam is collected by another optical fiber connected to the optical spectrometer. Because the optical absorption spectrum of the sample is so broad and changes primarily in amplitude rather than in spectral detail, it is sufficient to make dynamic measurement at a single wavelength. A measurement wavelength of 800 nm is utilized because this wavelength is near the peak of the absorption band, as indicated in FIG. 11.

FIG. 12 shows a typical recording of transmittance versus time for a nanoparticle WO₃:Pt powder dispersed on a filter paper. The transmittance of the sample decreases as the sample becomes more deeply colored. The rate of change in the transmittance reflects the rate of chemical reaction occurring in the WO₃.

The chemical reaction in a hydrogen/air mixture can be represented as:
Pd+xH₂+x/4O₂+WO₃←→H×WO₃+ x/2H₂O+Pd Eq. 1

From the simple nature of the chemical reaction the rate is expected to be first-order and the response is expected to exhibit an exponential shape as indeed it does. The recording may be fit to an exponential function to determine a characteristic time constant for the reaction. The simplest fitting function is:
T(t)=T₀+A₁exp(−(t−t₀)/tau) Eq. 2

Where the time constant, tau, is the time it takes for the transmittance to change by 1/e=1/2.718=0.37 of the total maximum change in transmittance. The time constant for the powder sample in FIG. 5 is 0.78 seconds.

The maximum change in transmittance will depend upon the thickness of the WO₃ layer in the indicator as well as the concentration of the hydrogen in the gas mixture.

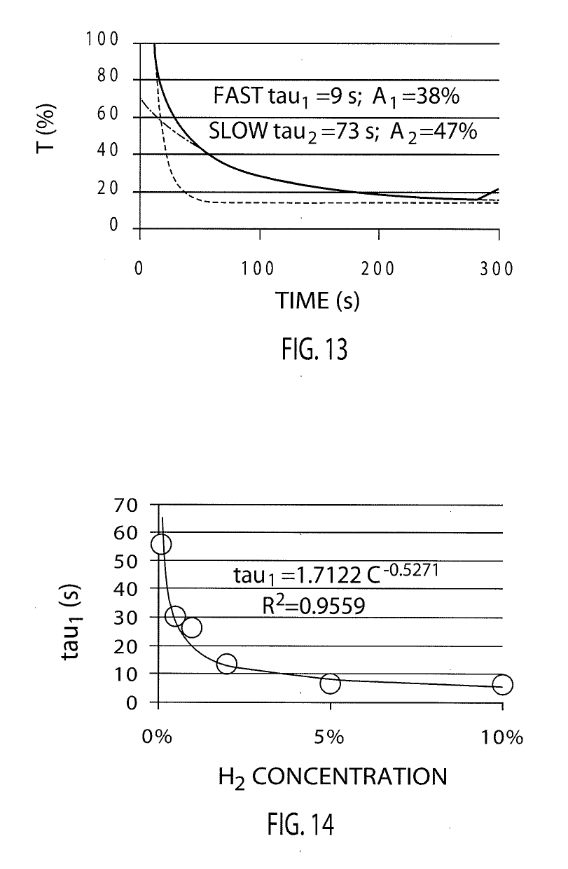

Most of the indicators have a somewhat more complex response. FIG. 13 shows another indicator response measurement that is better fit by a combination of two different exponential functions:
T(t)=T₀+A₁exp(−(t−t₀)/tau₁)+A₂exp(−(t−t₀)/tau₂) Eq. 3

This kind of response function is characteristic of two parallel first-order reactions, i.e., a faster reaction and a slower reaction.

The two different reaction rates occur because there are two different kinds of sites where the hydrogen actually reacts with the WO₃. The hydrogen gas first reacts with the catalyst where the hydrogen gas dissociated into atomic hydrogen. This atomic hydrogen may diffuse through the catalyst to the catalyst/WO₃ interface and react there, or the atomic hydrogen may diffuse over the surface of the catalyst and react at the edge of the catalyst island where the free surface of the catalyst meets the free surface of the WO₃. These two different kinds of reaction sites are expected to have significantly different reaction kinetics.

As is to be expected from the simple chemical reactions, the speed of reaction increases with hydrogen concentration (e.g. the time constant decreases). FIG. 14 shows the measured time constant as a function of hydrogen concentration. The speed of response is proportional to the square root of the hydrogen concentration as would be expected from the hydrogen molecule dissociation step in the reaction (Eq. 1).

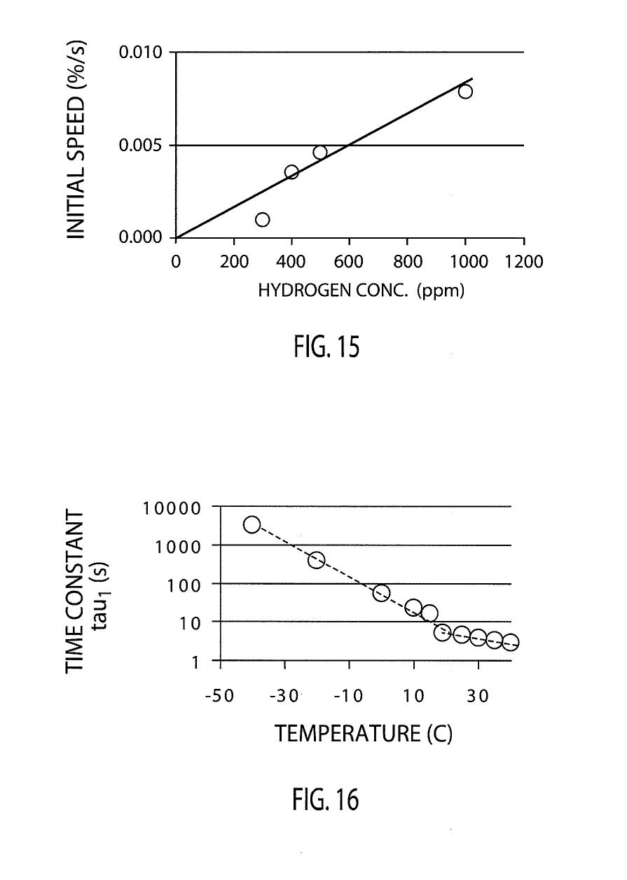

The response becomes slower and slower as the hydrogen concentration is decreased and exhibits a lower response limit of about 300 ppm H₂ in air as shown in FIG. 15.

The reaction rate also increases with temperature, as would be expected. FIG. 16 shows that the temperature dependence changes at around 15 C, i.e., the dependence changes more rapidly at lower temperatures than at higher temperatures.

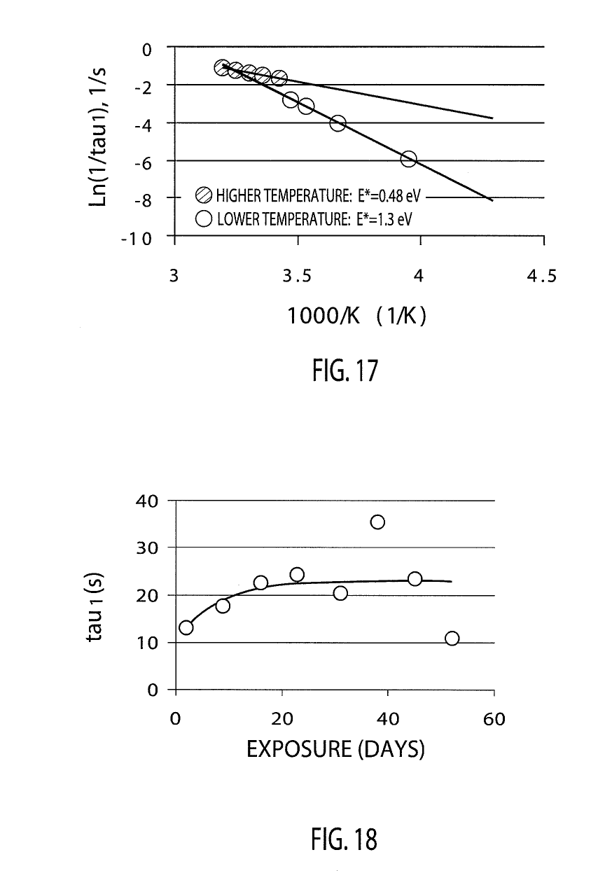

If we plot this same data on a log scale versus reciprocal temperature, as shown in FIG. 17, the two segments of temperature dependence illustrate two different thermal activation energies, i.e., a higher energy barrier for the reaction at temperatures below 15 C and a lower barrier above 15 C. The change may be due to the presence of a layer of water on the surface of the indicator at temperatures below the dew point. The water forms as a result of the reaction (Eq. 1) and may retard the further reaction of the hydrogen by competing for reaction sites on the catalyst surface and also by favoring the back reaction.

If an indicator is stored in a sealed container (such as a resealable polypropylene bag), it changes very little over time or not at all. However, if an indicator is exposed to the environment for a long period of time, its response slows significantly. This slowing is, at least in part, due to contamination by chemicals in the environment that adsorb strongly to the catalyst and block subsequent hydrogen reactions. Chemicals that are known to be particularly troublesome are sulfur bearing compounds such as H₂S, mercaptans and thiols, some hydrocarbons, and CO. The very thin PTFE top layer of the indicators helps to retard such contamination but does so imperfectly. Thicker protective layers and more dense protective layers applied by chemical vapor deposition slow the rate of contamination more, but also slow the indicator response.

FIG. 18 shows the trend of a thin film indicator's time constant over several weeks during which it was exposed to the laboratory air. There is a significant and variable change in the response time constant. Sometimes the variability can be associated with the changes in the chemicals being used in adjacent laboratory spaces. For example, a sudden increase in time constant was noted when a fellow chemist used thiols in a fume hood within our laboratory (see the data points at days 38 and 52). The time constant increased by more than 50% over a couple of days and then paradoxically recovered to a faster response within a couple of weeks. This kind of behavior is probably due to the reversible catalyst contamination by the errant thiol vapors.

If the degradation in response speed is primarily due to catalyst “poisoning,” then the progress of degradation over time in a particular environment may be anticipated. Assuming the concentration of the contaminant(s) were constant over time or that the daily average concentration of contaminates stayed fairly constant over time, the fraction of remaining un-poisoned catalyst sites attacked each day would be approximately constant. That is, the relative rate of decrease in speed should be constant. Under these conditions the speed should slow at an ever decreasing rate and asymptotically approach a limiting speed as all of the susceptible catalytic sites became blocked by contaminants. This kind of behavior is common and fits a well known functional relationship:
tau=tau₀+B₁(1−exp(−days/tauₓ)) Eq. 4

This function is fit to the data in FIG. 18. While the variability in the data is too great for a very good fit, the trend of the data appears to be consistent with the fitted function.

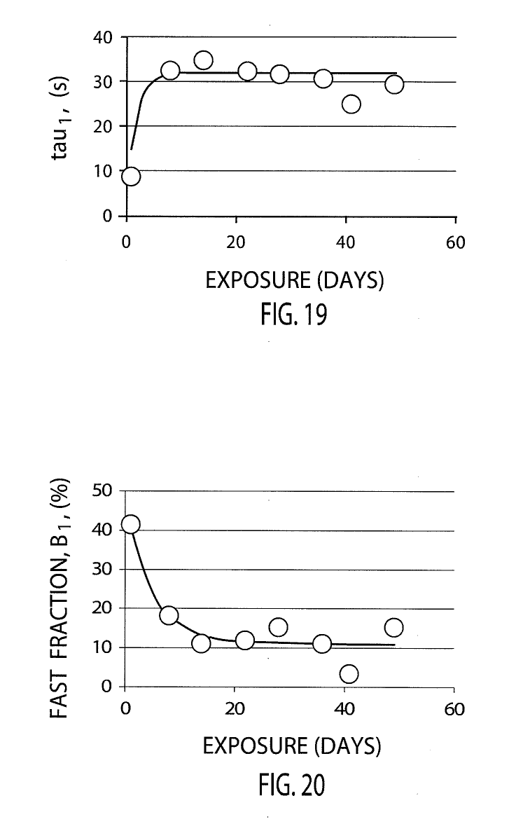

FIG. 19 shows another set of measurements of thin film indicators of slightly different design. The thin film indicators were also exposed to laboratory air and were tested in 0.5% H₂/N₂ mixture.

The fraction of the response that is due to the fast reaction component, the parameter A₁ in Eq. 3, represents the fraction of available fast reaction sites and by the same argument is also expected to follow a functional form like Eq. 4. FIG. 20 shows the measured parameter B1 and the fit to Eq. 4.

The ability to extrapolate short term testing results to longer time periods is helpful in determining long term results.

While several applications for these visual indicators do not require long term exposure to the environment, it is desirable to develop other indicators with long useful lives. Reliance upon abbreviated exposure tests to provide long term predictions will allow new designs to be developed without the necessity of waiting to determine if such new designs are viable alternatives. If mechanistically reasonable trend functions can be fit to short term data, then the extrapolation of these functions to provide useful estimates of long term behavior can reasonably be expected.

Mechanistic functions are disclosed above that seem to fit measured trends of response speed versus temperature and response speed versus hydrogen concentration and a trend of response speed versus exposure time in the environment. As indicated in Eq. 3, the response speed of an indicator fits a double exponential with four parameters, A₁, A₂, tau₁ and tau₂. If the trends of these parameters can be established within a short period of time, then extrapolation of these trends can be made and estimates can be made of the longer term behavior of the sensors.

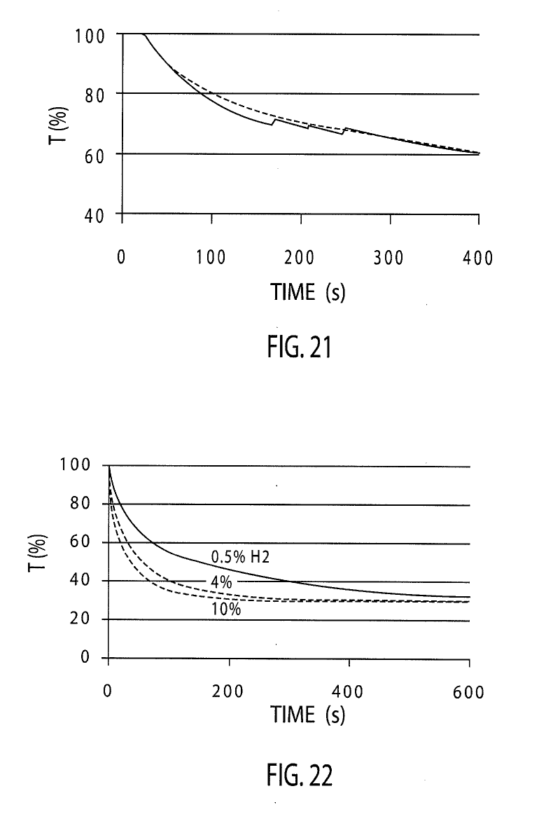

This has been done for the indicator used to obtain the data in FIGS. 19 and 20. FIG. 21 shows the measured response for this indicator after 49 days of exposure compared to the response calculated from the parametric model. The agreement is somewhat fortuitous but encouraging.

The curve fits for response speed versus hydrogen concentration and temperature can be used to estimate response speed under different conditions. For example, FIG. 22 shows the predicted response of this same sensor after 365 days exposure and exposed to different hydrogen concentrations of 0.5%, 4% and 10%.

Prototype visual indicators of gaseous hydrogen have been developed and characterized. Thin film tungsten oxide coatings on transparent polymers are suitable for indicating the presence of hydrogen at concentrations well below safe limits. In applications where the indicator film need not be exposed to the environment for many days, the response of these indicators is fast and reliable.

The present developmental devices react to the presence of hydrogen slower if they are exposed to the environment for long periods of time. The rate of slowing depends upon the nature of the environment as well as the design of the indicator. Improvement of the stability of the indicator has been achieved through use of the techniques developed to estimate long term performance from short term environmental test results. This ability should help in the design indicators with suitable durability for additional applications in various demanding environments.

Nanoparticle WO3:Pt powder is an excellent indicator pigment for paints, dies, coatings and inks. The chemochromic nanoparticles are easy to use as pigments in various types of emulsions and coatings. The chemochromic nanoparticles can be incorporated into many commercially available specialty coatings, paints, inks and dyes and applied as these products are normally applied. The visual sensors that can be constructed using the chemochromic nanoparticles are very inexpensive compared to bulky electronic sensors. As a result, the sensors reduce the risk to people and property by continuously indicating the presence or absence of leaking hydrogen. The nanoparticles are made to have a long life because of the mechanical durability and resistance to degradation in environments containing many pollutants.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of producing a hydrogen sensor using chemochromic nanoparticles comprising:
obtaining transition metal oxide nanoparticles;
coating said transition metal oxide nanoparticles with a catalyst; and,
using said chemochromic nanoparticles in a hydrogen sensor.

2. The method of claim 1 wherein the process of obtaining said transition metal nanoparticles comprises making said transition metal nanoparticles in a gas-phase reaction in a vacuum.

3. The method of claim 1 wherein the process of obtaining said transition metal nanoparticles comprises buying said transition metal nanoparticles.

4. The method of claim 1 wherein the process of obtaining said transition metal nanoparticles comprises dissolving finely divided transition metal powder in hydrogen peroxide.

5. The method of claim 1 wherein the process of obtaining said transition metal nanoparticles comprises spray pyrolysis.

6. The method of claim 1 wherein said step of using said chemochromic nanoparticles in a hydrogen sensor comprises combining said chemochromic nanoparticles with an emulsion that can be used in one of the group consisting of paints, dyes, inks and coatings, said emulsion providing a protective layer for said catalyst.

7. The method of claim 1 wherein said process of coating said transition metal nanoparticles with a catalyst comprises chemically reducing a transition metal oxide onto the surface of said nanoparticles.

8. The method of claim 1 wherein said process of reducing said catalyst to said transition metal nanoparticles comprises heating said nanoparticles in a forming gas.

9. A chemochromic hydrogen sensor that uses a pigment that is made from nanoparticles comprising:
nanoparticles of a transition metal oxide;
a catalyst that is reduced on a surface of said nanoparticles to form cemochromic nanoparticles for use as said pigment; and,
an emulsion that is combined with said chemochromic nanoparticles for use as a chemochromic hydrogen sensor, said emulsion providing a protective layer for said catalyst.

10. The chemochromic hydrogen sensor of claim 9 wherein said emulsion is suitable for use in at least one of the group consisting of paints, dyes, inks and coatings.

11. The sensor of claim 9 wherein said transition metal oxide is tungsten trioxide.

12. The sensor of claim 11 wherein said catalyst is platinum that has been coated on said nanoparticles of said transition metal oxide.
